(19) United States
(12) Patent Application Publication
(10) Pub. No.: US 2007/0233616 A1
(43) Pub. Date: Oct. 4, 2007

(54) Method for packaging greenhouse gas credits with a product transaction

(75) Inventors: Randall Ray Richards, Chillicothe, IL (US); James Edward Chapman, Washington, IL (US); Noel Joy Rytter, Dunlap, IL (US); Morton Herman Sill JR., Chillicothe, IL (US); Stephen John Pierz, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/392,678

(22) Filed: Mar. 30, 2006

(51) Int. Cl. G06F 17/00

(52) U.S. Cl. 705/400

(57) ABSTRACT

A method for packaging greenhouse gas credits with a product transaction includes determining an amount of greenhouse gas emissions associated with one or more products. The method also includes determining a quantity of greenhouse gas credits required to offset at least a portion of the greenhouse gas emissions of the one or more products. The method further includes determining a transaction price associated with the quantity of greenhouse gas credits. The method also includes providing a transaction package based on the determined purchase price associated with the greenhouse gas credits to a prospective customer.

### TECHNICAL FIELD

This disclosure relates generally to systems and methods for the transaction of greenhouse gas credits and, more particularly, to systems and methods for packaging greenhouse gas credits with a transaction of a particular product such as a machine, engine, or gas turbine.

### BACKGROUND

The emission of greenhouse gases into the environment is becoming a topic of concern within the international community. Greenhouse gas emissions are often attributed as the cause of climate change and the potentially adverse effects of changing weather patterns. Many countries have committed to reducing their greenhouse gas emissions through national and international agreements. Most notably, the ratification of the Kyoto Protocol commits developed member countries to reduce the total amount greenhouse gas emissions.

In order to meet greenhouse gas emissions reduction quotas, many governments of the member countries have enacted legislation that imposes limits on the amount of greenhouse gas emissions from facilities and other emission sources operating within the country. The governments may also impose fines and/or other penalties on organizations and those with operational accountability for facilities and other emission sources that exceed their target greenhouse gas emissions limits. Thus, there may be financial incentives for organizations operating in these countries to meet their target limits by engaging in the actual implementation of greenhouse gas emissions reduction processes and/or technologies or other emissions related activities such as the purchasing of greenhouse gas credits. Furthermore, if a greenhouse gas emissions source reduces emissions to a level below the target, then greenhouse gas credits can be generated from that source as a result. These greenhouse gas credits may be accumulated as an asset or sold to other entities wishing to receive and apply the greenhouse gas credits toward their greenhouse gas own emissions reduction target, thereby providing a purchase alternative to entities that may not otherwise be able to meet their greenhouse gas emissions reduction target through the application of new processes and/or technologies. As the provisions of the Kyoto Protocol and similar legislative measures become enforceable, the demand for greenhouse gas credits may significantly increase in order to comply with the requirements of these provisions. Thus, in order to address a potential increased demand for greenhouse gas credits, a system for marketing and trading of greenhouse gas emissions credits may be required.

At least one method for marketing and trading of greenhouse gas credits has been developed. For example, U.S. Patent Publication No. 2004/0039684 (“the '684 publication”) to Sandor describes the creation, maintenance, and operation of a greenhouse gas credit trading market. The system of the '684 publication includes a registry for storing emission credit information for each trading participant and a trading platform for enabling trades between participants based on the allowance and holding information. The system of the '684 publication may allow one or more participants to buy and sell greenhouse gas credits with other participants of the market. The trading platform may also allow participants to observe real-time trading activity.

Although the system of the '684 publication may allow participants to buy and sell greenhouse gas credits, it does not allow participants to market greenhouse gas credits for sale with other products or commodities as a package. Additionally, because the system of the '684 publication cannot package greenhouse gas credits with other products, entities that rely on purchasing greenhouse gas credits to offset greenhouse gas emissions generated by these products and/or other emission sources may require additional means to obtain greenhouse gas credits. For example, in certain situations, entities may desire or require additional accounting systems to ensure that that the acquisition of new greenhouse gas-emitting products are offset by an allocation of an appropriate amount of greenhouse gas credits. The disclosed method for packaging greenhouse gas credits with a product transaction is directed toward overcoming one or more of the problems set forth above.

### SUMMARY OF THE INVENTION

In accordance with one aspect, the present disclosure is directed toward a method for packaging greenhouse gas credits with a product transaction. The method may include determining an amount of greenhouse gas emissions associated with one or more products. The method may also include determining a quantity of greenhouse gas credits required to offset at least a portion of the greenhouse gas emissions of the one or more products. The method may further include determining a transaction price associated with the quantity of greenhouse gas credits. The method may also include providing a transaction package based on the determined purchase price associated with the greenhouse gas credits to a prospective customer.

According to another aspect, the present disclosure is directed toward a method for assembling a transaction package associated with a product based on a customer input. The method may include providing a selectable list of specifications to a customer. The method may also include receiving a specification selected by the customer. The method may further include identifying the product associated with the specification. The method may also include estimating a potential amount of greenhouse gas emissions associated with the product. The method may further include estimating a quantity of greenhouse gas credits that, when applied to a greenhouse gas emission balance, reduces the balance by at least a portion of the greenhouse gas emissions associated with the product. The method may also include determining a transaction price for the greenhouse gas credits and a product corresponding with the product specification. The method may further include providing a transaction package to the customer based on the transaction price.

In accordance with yet another aspect, the present disclosure is directed toward a computer system. The computer system may include a console, an input device coupled to the console, and a central processing unit in communication with the console and the input device. The central processing unit may be configured to determine an amount of greenhouse gas emissions associated with one or more products. The central processing unit may also be configured to determine a quantity of greenhouse gas credits required to offset at least a portion of the greenhouse gas emissions of the one or more products. The central processing unit may be further configured to determine a transaction price associated with the quantity of greenhouse gas credits. The central processing unit may also be configured to provide a transaction package based on the determined transaction price associated with the greenhouse gas credits to a prospective customer.

### BRIEF DESCRIPTION OF THE DRAWINGS

FIG. 1 illustrates an exemplary system for packaging greenhouse gas credits with a product transaction; and

FIG. 2 is a flowchart illustration of an exemplary disclosed method for assembling a transaction package associated with a product.

### DETAILED DESCRIPTION

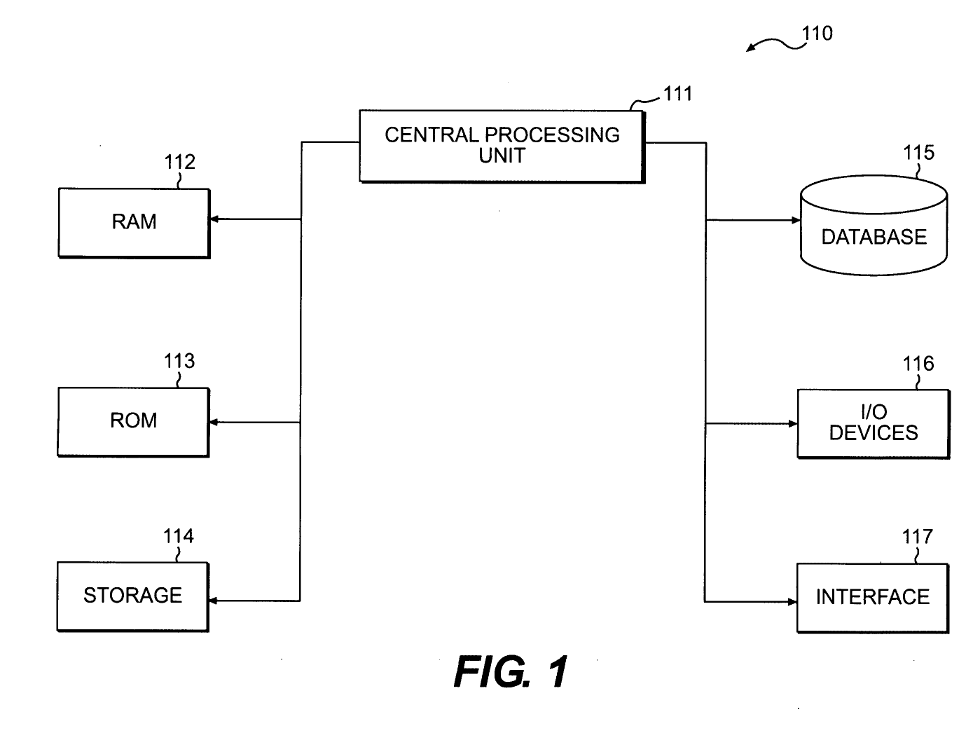

FIG. 1 illustrates an exemplary system 110 in which principles and methods consistent with the disclosed embodiments may be implemented. As shown in FIG. 1, system 110 may include one or more hardware and/or software components configured to collect, monitor, store, analyze, evaluate, distribute, report, process, record, and/or sort information associated with a proposed transaction of greenhouse gas credits. For example, system 110 may include one or more hardware components such as, for example, a central processing unit (CPU) 111, a random access memory (RAM) module 112, a read-only memory (ROM) module 113, a storage 114, a database 115, one or more input/output (I/O) devices 116, and an interface 117. Alternatively and/or additionally, system 110 may include one or more software components such as, for example, a computer-readable medium including computer-executable instructions for performing a method associated with a proposed transaction of greenhouse gas credit packages. For purposes of the present disclosure, transaction refers to any business transaction such as, for example, a sale, rental, lease, purchase, acquisition, or any other appropriate agreement for use of a particular product. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

CPU 111 may include one or more processors, each configured to execute instructions and process data to perform functions associated with system 110. As illustrated in FIG. 1, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, ROM 113 may load instructions into RAM 112 for execution by CPU 111.

Storage 114 may include any type of mass storage device configured to store any type of information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that store, organize, sort, filter, and/or arrange data used by system 110 and/or CPU 111. For example, database 115 may store historical information such as price information associated with a transaction of greenhouse gas credits, price information associated with a transaction of one or more products and/or types of products, or any other information that may be used by CPU 111 to determine a package price associated with a product specification. Similarly, database 115 may store emissions data associated with each type of product. Emissions data may include any information indicative of emissions associated with a particular type of product such as, for example, the type and amount of certain gases emitted by the product Emissions data may also include historical emissions data gathered from previous operations associated with the product. Emissions data may also include test data associated with an emissions test performed on various types of products. It is contemplated that database 115 may store additional and/or different information than that listed above.

I/O devices 116 may include one or more components configured to communicate information with a user associated with system 110. For example, I/O devices may include a console with an integrated keyboard and mouse to allow a user to input parameters associated with system 110. I/O devices 116 may also include a display including a graphical user interface (GUI) for outputting information on a monitor. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via any appropriate communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via any suitable communication network.

System 110 may be configured to collect, analyze, evaluate, report, and distribute information related to a potential transaction of one or more products. Non-limiting examples of products may include a vehicle, an engine system, a pump/motor configuration, a power plant, a turbine, and a machine system. According to one embodiment, the product may include a machine system that includes an internal combustion engine for performing a task associated with an industry such as mining, construction, farming, transportation, power generation, or any other type of industry. It is contemplated that a product may include any suitable article that can be packaged with greenhouse gas credits and sold to a customer as part of a transaction package. An exemplary method of operation of system 110 is described below.

Methods and systems consistent with the disclosed embodiments may allow an entity (e.g., dealer, manufacturer, etc.) to determine an amount of greenhouse gas emissions that may be produced by a particular machine and assemble a transaction package that includes the product and/or a quantity of greenhouse gas credits which may be applied to at least partially offset the amount of greenhouse gas emissions that may be produced by one or more products.

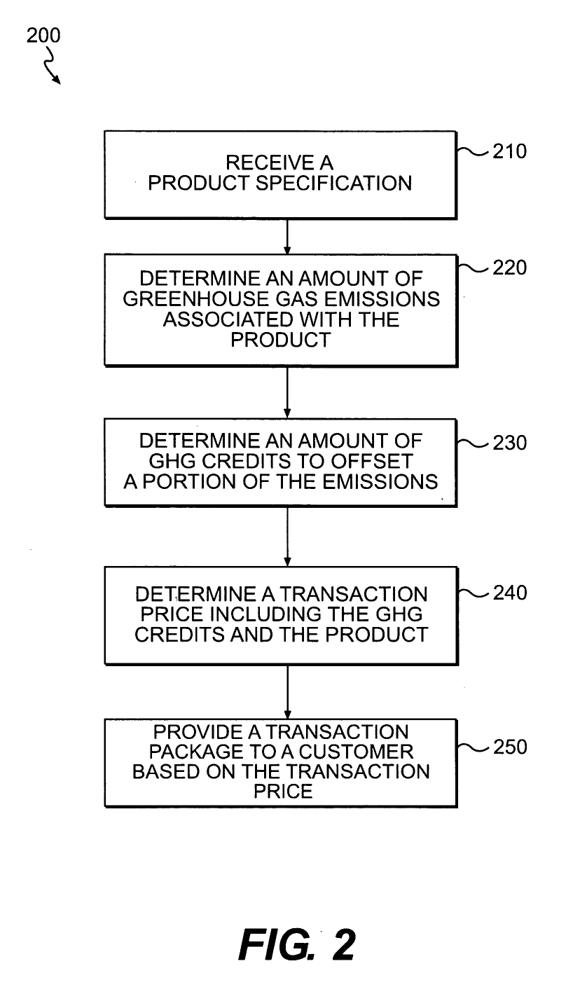

FIG. 2 provides a flowchart 200 illustrating an exemplary method for packaging greenhouse gas credits with a transaction of a product, consistent with the disclosed embodiments. As illustrated in FIG. 2, the method may include receiving one or more product specifications associated with a product, such as a machine (Step 210). For purposes of the present disclosure, product specifications may include any parameter, characteristic, or aspect associated with one or more products such as, for example, a machine type, function and/or quantity; an engine size; a hauling capacity; a fuel efficiency; a torque output; an indication of a predicted amount of machine use (i.e., vehicle miles, engine hours, operation times, etc.); an emission rating; or any other type of specification that may be indicative of one or more products requested by a customer.

These product specifications may be interrelated. For example, in response to a customer's product selection, a CPU 111 may access database 115 to select one or more predetermined product specifications (such as engine type, emission information, etc.) associated with the selected model. Alternatively and/or additionally, a customer may manually enter (or select from a list) certain product specifications to customize an equipment solution. This selection process may allow system 110 to assemble a product transaction package based on the specific needs of a customer.

CPU 111 associated with system 110 may receive product specifications from a customer via one or more I/O devices 116. Alternatively and/or additionally, CPU 111 may receive one or more product specifications from an online customer via the Internet. It is contemplated that product specifications may be received automatically or in response to a prompt provided by a software interface associated with system 110.

According to one exemplary embodiment, system 110 may be configured to provide an interactive software interface that prompts a customer for particular product specifications that may used in determining an equipment package. For example, the software interface may prompt a customer to select one or more types of products from a list of available products. In order to aid in the selection, system 110 may provide product specifications, including various operational parameters associated with the product and/or product systems.

Upon receipt of the product specifications, system 110 may identify a product associated with the received product specifications. For example, CPU 111 may search database 115 to identify a particular product that corresponds to the specifications supplied by the customer. Alternatively and/or additionally, CPU 111 may identify a list of products that may correspond to at least some of the specifications and provide the list to the customer. The customer may then select one or more products from the list.

System 110 may determine an amount of greenhouse gas emissions associated with the product (Step 220) based on a customer input, average usage statistics, emission data associated with operations of the product, and/or test data associated with the product. The emission level may include one or more emission quantities associated with greenhouse gas emissions produced during the operation of the machine. The emissions level may be expressed as an emissions rate, such as pounds per hour, metric tons per year, etc. According to one embodiment, emissions levels may be estimated, monitored, and/or extrapolated based on data gathered or monitored from one or more operations of the products or may be obtained through emissions testing for various products and product configurations during design, manufacture, and/or operation of one or more of the products.

According to one embodiment, determining an amount of emissions may include estimating the amount of potential emissions based on average usage statistics of the product. For example, system 110 may predict, based on historical operation and/or test data associated with the machine, an amount of greenhouse gas emissions associated with one or more products, based on an anticipated, predicted, and/or estimated amount of use of the product (e.g., hours/day, hours/year, miles/year, etc.).

Alternatively, a software interface associated with system 110 may provide a customer with a list of expected operational levels (e.g., 1500 annual hours, 2500 annual hours, etc.), from which a customer may select one or more levels. Once the customer makes a selection, CPU 111 may access historical emissions data stored in database 115 corresponding to the expected operational level of the appropriate product type and use this historical data as the determined emissions level for the product.

Alternatively, determining an amount of emissions may include monitoring the emissions during operations associated with the one or more products. For example, system 110 may receive data indicative of operations associated with one or more of the products. System 110 may subsequently determine an amount of emissions based on the received operation data.

Upon determining the emissions levels associated with one or more products, a quantity of greenhouse gas credits associated with the determined emissions level may be estimated (Step 230). The prediction may be based on a number of greenhouse gas credits that may be required to at least partially offset the estimated emissions level that may be produced by the product. The prediction may also be based on information provided by a customer. For example, a customer may desire to purchase greenhouse gas credits with each product that may reduce the balance of greenhouse gas emissions by a certain percentage of the estimated emissions produced by the products. Alternatively, the prediction may include a quantity of greenhouse gas credits to offset all of the determined greenhouse gas emissions that may be produced by each product.

Once an amount of greenhouse gas credits has been estimated and/or determined, a price associated with a transaction of an equipment package may be determined (Step 240). For example, system 110 may be configured to determine and/or calculate a package price that includes one or more products and/or greenhouse gas credits to be included with the machine. In one embodiment, the package price may include a retail price of the product added to a fair market value of greenhouse gas credits determined by calculating the price per credit traded on one or more of the greenhouse gas credit markets. Alternatively and/or additionally, a value of the greenhouse gas credits may be determined by analyzing historical data associated with greenhouse gas credit pricing, predicting a future demand associated with the greenhouse gas credits, and adjusting the fair market value accordingly.

The package price may also include discount prices which may provide an added incentive for customers to purchase, rent, lease, or use the product bundled with the greenhouse gas credits. This discount price may be determined as some percentage of the value associated with the product and/or the greenhouse gas credits.

System 110 may also include profit analysis software that analyzes and/or optimizes a maximum profit margin. It is contemplated that a plurality of equipment packages may be included, each with different pricing depending upon the number of products ordered and/or a quantity of greenhouse gas credits to be provided. It is further contemplated that these prices may either be predetermined or customized based on the needs of a particular customer.

Once a package price has been calculated, a transaction package may be provided to the customer (Step 250). Providing the transaction package to the customer may include itemizing the quantity and type of products included in the package, the price associated with each product, the number of greenhouse gas credits included with the package, a price associated with the greenhouse gas credits and, optionally, a discounted total package price. According to another embodiment, the transaction package may also include an option to purchase a greenhouse gas maintenance package. The maintenance package may include periodic analysis of greenhouse gas emissions levels for one or more of the products during a specified period. The maintenance package may also include an option for the customer to “lock in” greenhouse gas credit pricing, at a fixed price or at a price linked to the market should the emission analysis indicate that additional greenhouse gas credits may be required to offset an emission level due to an increase in the estimated greenhouse gas emission level associated with the product (e.g., the product is producing more emissions than the customer or system initially predicted).

Once assembled, the transaction package may be transmitted to the customer via I/O devices 116. Alternatively and/or additionally the transaction package may be transmitted to the customer via communication network, such as over the internet, to an online customer.

### INDUSTRIAL APPLICABILITY

Although the disclosed methods for selling greenhouse gas credits as part of a transaction package are described in connection with products that emit greenhouse gas credits, it is contemplated that the methods may be implemented with any product where the acquisition of greenhouse gas credits may be useful. Specifically, processes consistent with the disclosed embodiments may provide methods for providing greenhouse gas credits as part of a package to customers that purchase, lease, rent, or otherwise use products that are potentially sources of greenhouse gas emissions.

The presently disclosed method for packaging greenhouse gas credits with a product transaction may have several advantages. For example, in markets where greenhouse gas emissions are regulated and restricted, methods consistent with the disclosed embodiments may allow customers purchasing new products that are sources of greenhouse gas emissions to purchase greenhouse gas credits as part of a package to offset the potential increases to their overall greenhouse gas emissions balance. As a result, customers wishing to reduce their greenhouse gas emissions balance may not require additional resources to monitor an impact of the acquisition of greenhouse gas emissions-producing products, since the potential greenhouse gas emissions may be offset with the purchase of the package.

Additionally, because system 110 packages greenhouse gas credits with products that emit greenhouse gas emissions, buyers and sellers may establish a marketplace independent of traditional trading markets for greenhouse gas credits, which may reduce extreme price fluctuation that is sometimes characteristic of traditional commodity markets. As a result, methods consistent with the disclosed embodiments may provide increased price stability and reliability not typically associated with traditional commodity markets.

Furthermore, by packaging greenhouse gas credits with product transactions, system 110 may provide customers with a convenient method for reducing a greenhouse gas emissions balance. For example, system 110 may provide a “one-stop-shop” approach to selling greenhouse gas credits by allowing customers to purchase, rent, lease, or use greenhouse gas emission-generating products and greenhouse gas credits in the same place. As a result, there may be a decreased need for additional systems or personnel dedicated to tracking greenhouse gas emissions levels of newly acquired equipment and ensuring the appropriate number of greenhouse gas credits are obtained to offset any increase in greenhouse gas emissions due to these acquisitions.

It will be apparent to those skilled in the art that various modifications and variations can be made to the disclosed system and method for packaging of greenhouse gas credits with a product transaction without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for packaging greenhouse gas credits with a product transaction comprising:
determining an amount of greenhouse gas emissions associated with one or more products;
determining a quantity of greenhouse gas credits required to offset at least a portion of the greenhouse gas emissions of the one or more products;
determining a transaction price associated with the quantity of greenhouse gas credits; and
providing a transaction package based on the determined purchase price associated with the greenhouse gas credits to a prospective customer.

2. The method of claim 1, wherein determining an amount of greenhouse gas emissions includes:
receiving emission data collected during operations associated with the one or more products; and
determining the amount of greenhouse gas emissions based on the collected emission data.

3. The method of claim 1, wherein determining an amount of greenhouse gas emissions includes:
receiving one or more equipment specifications associated with the one or more products; and
estimating the amount of greenhouse gas emissions based on the received equipment specifications.

4. The method of claim 3, wherein the one or more equipment specifications include at least one of a product type, a product configuration, a product model, an expected amount of operation, and an emission level.

5. The method of claim 1, wherein determining the quantity of greenhouse gas credits is based on an offset amount provided by the prospective customer.

6. The method of claim 5, wherein the offset amount includes a percentage of the estimated amount of greenhouse gas emissions associated with the one or more products.

7. The method of claim 1, wherein determining the transaction price includes:
analyzing historical data associated with previous transactions of greenhouse gas credits;
analyzing a market value associated with current transactions of greenhouse gas credits; and
establishing the transaction price based on at least one of the historical data analysis and the market value analysis.

8. The method of claim 7, wherein establishing the transaction price includes:
estimating a future demand based on the historical data; and
adjusting the transaction price based on the estimated future demand.

9. The method of claim 1, wherein providing the transaction package includes:
establishing a transaction price associated with the one or more products; and
generating a transaction offer comprising the sum of the transaction price associated with the one or more products and the transaction price associated with the quantity of greenhouse gas credits.

10. The method of claim 9, wherein generating the transaction offer includes providing an option for the prospective customer to purchase additional greenhouse gas credits at a discounted rate.

11. The method of claim 9, wherein the transaction offer may include a discount associated with one or more of the transaction price associated with the one or more products and the transaction price associated with the quantity of greenhouse gas credits.

12. A computer readable medium for use on a computer system, the computer readable medium having computer executable instructions for performing the method of claim 1.

13. A method for assembling a transaction package associated with a product based on a customer input comprising:
providing a selectable list of specifications to a customer;
receiving a specification selected by the customer;
identifying the product associated with the specification;
estimating a potential amount of greenhouse gas emissions associated with the product;
estimating a quantity of greenhouse gas credits that, when applied to a greenhouse gas emission balance, reduces the balance by at least a portion of the greenhouse gas emissions associated with the product;
determining a transaction price for the greenhouse gas credits and a product corresponding with the product specification; and
providing a transaction package to the customer based on the transaction price.

14. The method of claim 13, wherein the specification includes information provided by a customer and receiving the specification includes:
prompting the customer to select a product from among a plurality of products;
prompting the customer to enter a number of estimated number of hours of operation associated with the selected product; and
collecting information provided by one or more customer responses to the prompts.

15. The method of claim 13, wherein the transaction package includes an emission maintenance option, wherein the emission maintenance option includes one or more of:
monitoring of greenhouse gas emissions associated with the product during specified intervals of product use;
evaluating whether the estimated quantity greenhouse gas credits are sufficient based on the monitoring; and
providing, to the customer, an option to purchase additional greenhouse gas credits based on the evaluation.

16. A computer readable medium for use on a computer system, the computer readable medium having computer executable instructions for performing the method of claim 13.

17. A computer system comprising:
a console;
an input device coupled to the console;
a central processing unit, in communication with the console and the input device, the central processing unit configured to:
determine an amount of greenhouse gas emissions associated with one or more products;
determine a quantity of greenhouse gas credits required to offset at least a portion of the greenhouse gas emissions of the one or more products;
determine a transaction price associated with the quantity of greenhouse gas credits; and
provide a transaction package based on the determined transaction price associated with the greenhouse gas credits to a prospective customer.

18. The system of claim 17, wherein determining an amount of greenhouse gas emissions includes:
receiving emission data collected during operations associated with the one or more products; and
determining the amount of greenhouse gas emissions based on the collected emission data.

19. The system of claim 17, wherein determining an amount of greenhouse gas emissions includes:
receiving, via the input device, an equipment specification associated with the one or more products; and
estimating the amount of greenhouse gas emissions based on the received equipment specifications.

20. The system of claim 19, wherein the one or more equipment specifications include at least one of a product type, a product configuration, a product model, an expected amount of operation, and an emission level.

21. The system of claim 17, wherein determining the transaction price includes:
analyzing historical data associated with a previous transaction of greenhouse gas credits;
analyzing a market value associated with current transactions of greenhouse gas credits; and
establishing the transaction price based on at least one of the historical data analysis and the market value analysis.

22. The system of claim 17, wherein providing the transaction package includes:
establishing a transaction price associated with the one or more products; and
generating a transaction offer comprising the sum of the transaction price associated with the one or more products and the purchase price associated with the quantity of greenhouse gas credits.
